(19) United States
(12) Patent Application Publication
(10) Pub. No.: US 2025/0314773 A1
(43) Pub. Date: Oct. 9, 2025

(54) Localization and velocity measurement using coherent optical sensing

(71) Applicant: LYTE AI, INC., Mountain View, CA (US)

(72) Inventors: Andrew J.H. Sutton, Amaroo (AU); Arman Hajati, San Carlos, CA (US); Alexander Shpunt, Saratoga, CA (US); Michael Brand, Bentleigh East (AU)

(21) Appl. No.: 18/867,818

(22) PCT Filed: May 28, 2023
(86) PCT No.: PCT/US2023/067587

§ 371 Date: Nov. 21, 2024

Related U.S. Application Data
(60) Provisional application No. 63/346,866, filed on May 29, 2022.
(60) Provisional application No. 63/415,297, filed on Oct. 12, 2022.

(51) Int. Cl. G01S 17/89; G01S 7/481; G01S 17/58

(52) U.S. Cl. CPC G01S 17/89; G01S 7/4811; G01S 17/58

(57) ABSTRACT

A method for sensing includes transmitting multiple beams of coherent optical radiation at different, respective beam angles from an array of transceivers (40) mounted on a platform (20). At two or more of the transceivers, reflections of the beams are received from two or more different, respective surfaces (56, 57. 58) at different, respective orientations relative to the platform. The received reflections are processed at the transceivers coherently with the transmitted beams to extract displacement parameters of the transceivers relative to the respective surfaces. Coordinates of the platform are computed based on the displacement parameters.

### CROSS-REFERENCE TO RELATED APPLICATIONS

This application claims the benefit of U.S. Provisional Patent Application 63/346,866, filed May 29, 2022, and of U.S. Provisional Patent Application 63/415,297, filed Oct. 12, 2022. The disclosures of these related applications are incorporated herein by reference.

### FIELD OF THE INVENTION

The present invention relates generally to methods and devices for sensing location and movement, and particularly to optical techniques for this purpose.

### BACKGROUND

Many applications require finding the position of an item (referred to as “localization”) in real time with six degrees of freedom (6-DoF)—three location coordinates and three angular coordinates. For example, an augmented reality (AR) headset requires accurate, high-speed localization to ensure that the images projected by the headset maintain registration with the real-world environment viewed by the user as the user's head translates and rotates. Robots, autonomous vehicles, and drones similarly require rapid updates of their location and velocity.

Some solutions to problems of real-time localization use a combination of an inertial sensor (IMU), Global Positioning System (GPS) receiver, and cameras or other optical sensors that are mounted on the item itself and/or in the vicinity of the item. When used in an uncontrolled environment, these solutions are prone to error and sensitive to optical and radio frequency (RF) interference (and GPS signals may not be available at all in some locations). In many cases they are unable to keep up precisely with rapid motion of the item that is to be localized.

Some localization systems use frequency-modulated continuous-wave (FMCW) LIDAR. In such systems, a radio-frequency (RF) chirp is applied to modulate the frequency of a laser beam that is directed toward a target. The light reflected from the target is mixed with a sample of the transmitted light and detected by a photodetector, such as a balanced photodiode, which then outputs an RF signal at a beat frequency that is proportional to the distance to the target. When the target is moving, the resulting Doppler shift of the reflected light will cause the beat frequency to increase or decrease, depending on the direction of motion. By comparing the beat frequencies obtained from chirps of positive and negative slopes, it is thus possible to extract both the range and the velocity of the target.

U.S. Patent Application Publication 2021/0373157, for example, describes an FMCW Doppler LIDAR system and method for use in a host vehicle. The system includes a laser system, lenses, a homodyne receiver, and a signal processing unit (SPU). The lenses transmit laser beams toward a target-of-interest, and receive return beams reflected from the target-of-interest. The SPU calculates a range and/or velocity relative to the target-of-interest using the estimated sign, and controls the host vehicle using the range and/or velocity.

The terms “optical.” “light,” and “optical radiation,” as used in the present description and in the claims, refer to electromagnetic radiation in any of the visible, infrared, and ultraviolet spectral ranges.

### SUMMARY

Embodiments of the present invention that are described hereinbelow provide improved systems, devices, and methods for optical sensing.

There is therefore provided, in accordance with an embodiment of the invention, a method for sensing, which includes transmitting multiple beams of coherent optical radiation at different, respective beam angles from an array of transceivers mounted on a platform. At two or more of the transceivers, reflections of the beams are received from two or more different, respective surfaces at different, respective orientations relative to the platform. The received reflections are processed at the transceivers coherently with the transmitted beams to extract displacement parameters of the transceivers relative to the respective surfaces. Coordinates of the platform are computed based on the displacement parameters.

In some embodiments, at least two of the surfaces from which the reflections are received are oriented relative to the platform at respective orientation angles that differ by more than 10°. In a disclosed embodiment, the respective orientation angles differ by 90°.

In some embodiments, the array of transceivers is disposed on a photonic integrated circuit (PIC). Additionally or alternatively, the transceivers in the array have respective fields of view, which are not mutually overlapping.

In some embodiments, the displacement parameters are selected from a set of parameters consisting of radial distances and radial velocities relative to the surfaces. In one embodiment, processing the received reflections further includes extracting a transverse velocity of at least one of the transceivers by detecting movement of a laser speckle pattern cast by at least one of the beams on at least one of the surfaces. In a disclosed embodiment, detecting the movement includes sensing changes in an intensity of the reflections using a matrix of photodetectors adjacent to the at least one of the transceivers. Alternatively, detecting the movement includes sensing changes in a transverse mode of the reflections received by a group of edge-coupled waveguides.

In a disclosed embodiment, computing the coordinates includes computing location coordinates of the platform. Additionally or alternatively, computing the coordinates includes computing velocity coordinates of the platform. In one embodiment, computing the velocity coordinates includes computing three linear components and three angular components of a velocity of the platform. Additionally or alternatively, computing the coordinates includes integrating the velocity coordinates over time to find location coordinates of the platform.

In a disclosed embodiment, transmitting the multiple beams includes transmitting three or more of the beams of coherent optical radiation along three or more different, non-intersecting axes.

In one embodiment, the platform includes a headset. In another embodiment, the platform includes a vehicle.

In some embodiments, the method includes mapping an environment of the platform using the extracted displacement parameters.

There is also provided, in accordance with an embodiment of the invention, a method for sensing, which includes transmitting three or more beams of coherent optical radiation along three or more different, non-intersecting axes from an array of transceivers mounted on a platform. At the transceivers, reflections of the beams are received from one or more surfaces along the different, non-intersecting axes. The received reflections are processed at the transceivers coherently with the transmitted beams to extract displacement parameters of the transceivers relative to the one or more surfaces. Coordinates of the platform are computed based on the displacement parameters.

In some embodiments, transmitting the three or more beams includes transmitting at least six beams of the coherent optical radiation along different, respective axes, forming at least three sets of the axes such that the axes in each set do not intersect with the axes in any of the other sets. In a disclosed embodiment, the extracted displacement parameters include respective radial velocities along the respective axes relative to the one or more surfaces. Computing the coordinates may include computing three linear components and three angular components of a velocity of the platform. Alternatively or additionally, computing the coordinates includes integrating the linear and angular components of the velocity over time to find location coordinates of the platform.

In some embodiments, the displacement parameters are selected from a set of parameters consisting of radial distances and radial velocities relative to a surface. In a disclosed embodiment, computing the coordinates includes computing a linear combination of the displacement parameters.

In the disclosed embodiments, computing the coordinates includes computing location coordinates of the platform and/or computing velocity coordinates of the platform.

In a disclosed embodiment, the one or more surfaces include multiple different surfaces, including first and second surface on which at least first and second ones of the beams of coherent optical radiation are incident, and the method includes computing a velocity of the second surface relative to the first surface based on the displacement parameters.

There is additionally provided, in accordance with an embodiment of the invention, sensing apparatus, including an array of transceivers, which are configured for mounting on a platform and are configured to transmit multiple beams of coherent optical radiation at different, respective beam angles, to receive at two or more of the transceivers reflections of the beams from two or more different, respective surfaces at different, respective orientations relative to the platform, to mix the received reflections coherently with the transmitted beams, and to output signals responsively to the mixed reflections. A processor is configured to process the signals to extract displacement parameters of the transceivers relative to the one or more surfaces and to compute coordinates of the platform based on the displacement parameters.

There is further provided, in accordance with an embodiment of the invention, apparatus for sensing, including an array of transceivers, which are configured for mounting on a platform and are configured to transmit three or more beams of coherent optical radiation along three or more different, non-intersecting axes, to receive reflections of the beams from one or more surfaces along the different, non-intersecting axes, to mix the received reflections coherently with the transmitted beams, and to output signals responsively to the mixed reflections. A processor is configured to process the signals to extract displacement parameters of the transceivers relative to the one or more surfaces and to compute coordinates of the platform based on the displacement parameters.

The present invention will be more fully understood from the following detailed description of the embodiments thereof, taken together with the drawings in which:

### BRIEF DESCRIPTION OF THE DRAWINGS

FIG. 1 is a schematic pictorial view of an AR headset with 6-DoF localization, in accordance with an embodiment of the invention;

FIG. 2 is a schematic side view of a sensing device, in accordance with an embodiment of the invention;

FIG. 3 is a schematic frontal view of a sensing element, in accordance with an embodiment of the invention;

FIG. 4 is a schematic pictorial illustration of an AR headset in use in localizing a subject in an indoor environment, in accordance with an embodiment of the invention;

FIG. 5 is a block diagram that schematically illustrates functional elements of the localization operation performed in FIG. 4, in accordance with an embodiment of the invention;

FIG. 6 is a schematic frontal view of a multi-pixel sensor used in a localization system, in accordance with an embodiment of the invention;

FIG. 7 is a schematic frontal view of a sensor array used in a localization system, in accordance with an embodiment of the invention;

FIG. 8 is a schematic pictorial view of a multi-pixel sensor used in a localization system, in accordance with another embodiment of the invention;

FIG. 9 is a schematic side view of a sensing device, in accordance with yet another embodiment of the invention; and

FIG. 10 is a schematic pictorial view of a sensor array used in a localization system, in accordance with a further embodiment of the invention.

### DETAILED DESCRIPTION OF EMBODIMENTS

### Overview

Embodiments of the present invention that are described address the need for real-time localization and velocity estimation that is accurate, robust, and low in cost. The disclosed solutions are based on coherent optical sensing, in novel configurations that can work in a wide range of environments and applications. These coherent sensing arrangements can be used on their own to compute location, orientation, and velocity coordinates of a platform with up to six degrees of freedom, i.e., including three linear components (X, Y, Z) and three angular components (pitch, roll, and yaw) of the position and/or velocity. Alternatively, they may be used in conjunction with other sensing modalities, such as inertial sensors and radio geolocation systems.

The embodiments that are described herein use sensing devices comprising a sparse array of coherent optical transceivers, for example an array of frequency-modulated continuous-wave (FMCW) LIDAR transceivers, which are mounted on the platform that is to be localized. The array is “sparse” in the sense that a small number of sensing pixels (for example, 1000 pixels or less, or even fewer than 10 pixels) is used to cover a large overall angular field of view (for example 10°×10° or more); and the individual fields of view of the pixels may not overlap with the neighboring transceivers. Such an array may be implemented compactly and inexpensively on a photonic integrated circuit (PIC), as described further hereinbelow. Although the embodiments described herein use particular FMCW LIDAR configurations, the principles of the present invention may similarly be applied using other coherent sensing techniques, such as Random Phase Modulation LIDAR, and using either direct modulation of the transmitted laser beam or external modulation.

Each transceiver in such a coherent sensing array emits a modulated beam of coherent radiation and processes the reflected radiation coherently with the transmitted beam. (The individual transceivers in the array are also referred to as “pixels.”) This coherent processing gives rise to an output signal that includes a beat frequency, which varies depending on displacement parameters, i.e., distance and velocity, of the transceiver relative to the surface from which the radiation has been reflected. The signal is processed to measure both the distance to the point from which the beam is reflected back to the sensing device and the instantaneous radial velocity of this point relative to the sensing device (or equivalently, to measure the radial velocity of the sensing device itself).

By appropriate alignment of the wide field of view of the sensing device, at least several of the transceivers will sense reflections from one or more stationary surfaces, such as the floor or the ground, or possibly, when the device is used in a room or other enclosed space, the walls and ceiling and/or other objects in this space. A processor uses the resulting displacement parameters to compute location and/or velocity coordinates that are indicative of the location and velocity of the sensing device, and consequently of the platform to which the sensing device is attached. More specifically, in some embodiments, the processor finds the coordinates by computing appropriate linear combinations of the displacement parameters extracted from the transceiver signals.

In some embodiments, the array of transceivers is arranged to transmit the beams of coherent radiation at different, respective beam angles from different transceivers. (The array for this purpose may, for example, be disposed on a single PIC or may comprise sub-arrays on different PICs, which are mounted in different, respective locations and/or orientations on the platform.) In this arrangement, the beams may reflect back to different transceivers from two or more different surfaces, at different, respective orientations relative to one another. In an urban or indoor environment, for example, the orientations of the surfaces typically differ by at least 10° and may differ by 90°, such as when the reflections come from the floor, the walls, and possibly the ceiling.

Additionally or alternatively, in some embodiments, the transceiver array is configured to transmit three or more beams of coherent optical radiation along three or more different, non-intersecting axes. In this context, to determine whether the axes of the beams intersect, the optical axes of the beams are considered to extend as lines in three-dimensional space, in both forward and backward directions relative to the transceivers. The beams have the form of narrow cones, with a width that is defined, at any point along the axis in the forward direction, by the lateral distance from the axis at which the amplitude of the beam drops to l/e relative to the amplitude on axis. If there is no overlap between these beam cones (including the projection of the cones in the backward direction behind the transceivers), the axes are considered to be non-intersecting. When the axes are non-intersecting, the processor is able to compute at least the velocity of the platform with 6-DoF based solely on the radial velocities along the beam axes that are derived from the signals output by the transceivers. The velocity can be integrated over time to give accurate location coordinates independently of any other sensing modality. Additionally or alternatively, the processor can extract and make use of the radial distances indicated by the transceiver signals.

In some of these embodiments, the array comprises more than three transceivers, which are grouped in at least three sets, such that the axes of the beams in each set do not intersect with the axes in any of the other sets (although the axes within a given set may intersect with one another). Such configurations can likewise be used in sensing 6-DoF velocity in the manner described above, and the use of a larger number of beams can be helpful in enhancing the accuracy and robustness of the coordinate measurements.

For example, in one embodiment a coherent sensing device transmits modulated coherent beams along at least six mutually independent axes and senses the Doppler shift of each reflected beam, thus finding the radial velocity along each axis. A processor combines the Doppler-based velocity measurements to derive the absolute velocity of the coherent sensing device with six DoF, independently of the location of the device and of any other sensing modalities. As long as the environment is largely stationary, this mode of measurement is resistant to drift and environmental interference. Devices of this sort can be used, for example, in navigation of both manned and unmanned vehicles, as well as in augmented reality applications.

Additionally or alternatively, when the environment includes moving surfaces (such as surfaces or moving vehicles or other objects), and beams output by the device are incident on different surfaces in the environment, a processor may process the signals to compute the velocity of one of the surfaces relative to another.

In some embodiments, the coherent sensing device also measures the intensity of the reflected radiation that is received in the area of each transceiver. This capability can be used in sensing transverse motion of the device relative to a stationary surface, in addition to the capability of the transceivers to sense radial motion. When the coherent beam emitted by a given transceiver is incident on a rough surface, it gives rise to a laser speckle pattern due to coherent scattering from the surface. Because coherent sensing requires a coherent source, speckle is naturally formed in the process and can be used to enhance the measurement of displacement parameters. Small transverse shifts of the beam across the surface (due to movement of the sensing device) will cause the image of the speckle pattern on the sensor to shift transversely, as well. The image of the speckle pattern is captured by the sensing device and is analyzed to measure the directions and magnitudes of the speckle shifts. The measurements of speckle shift over short times thus provide an accurate indication of the instantaneous transverse velocity, i.e., the direction and speed of translation and rotation of the sensing device in a plane that is parallel to the surface where the speckle pattern appears. These measurements can be integrated over time to track the transverse location and velocity of the platform to which the sensing device is attached.

Alternatively, coherent sensing devices in accordance with other embodiments of the invention can be used to sense only radial range and velocity, without necessarily sensing transverse motion by speckle analysis. These radial measurements are sufficient in some applications for real-time localization of the platform on which the sensing device is mounted. In such embodiments, it can be advantageous to use a sensing device with a wide field of view (for example, more than 90°) or to use two or more sensing devices fixed in different locations to the platform that is to be localized, to enable sensing of ranges and velocities with respect to multiple surfaces in the environment of the item.

The present embodiments thus enable a sensing device to localize the platform to which the device is fixed continuously, with six DoF in real time. The signals output by the sensing device can also be used (given a wide field of view and sufficient computational power) in mapping the environment of the sensing device, thus providing simultaneous localization and mapping (SLAM) capability. Sensing devices in accordance with embodiments of the invention can be used independently of other sensing modalities and independently of any externally generated signals or fields.

Alternatively, sensing devices in accordance with embodiments of the invention can be used in conjunction with other sensing modalities used in localization, such as image analysis, inertial sensing, and/or sensing of radio frequency (RF) fields, as in Global Positioning System (GPS) sensors. Coherent sensing in accordance with the present embodiments offers directly sensed, high-quality velocity information, which can be used in mitigating drift errors in the measured velocity that commonly occur in the sorts of acceleration-based sensors that are typically used in inertial measurement unit (IMU) applications.

Although the embodiments described hereinbelow relate specifically to the use of such sensing devices in AR applications, the principles of these devices may be adapted, mutatis mutandis, for use in other applications that require rapid 6-DoF sensing, such as robotics, autonomous vehicles, drone aircraft, toys, IoT devices, and remote controllers.

### Sensing Configurations

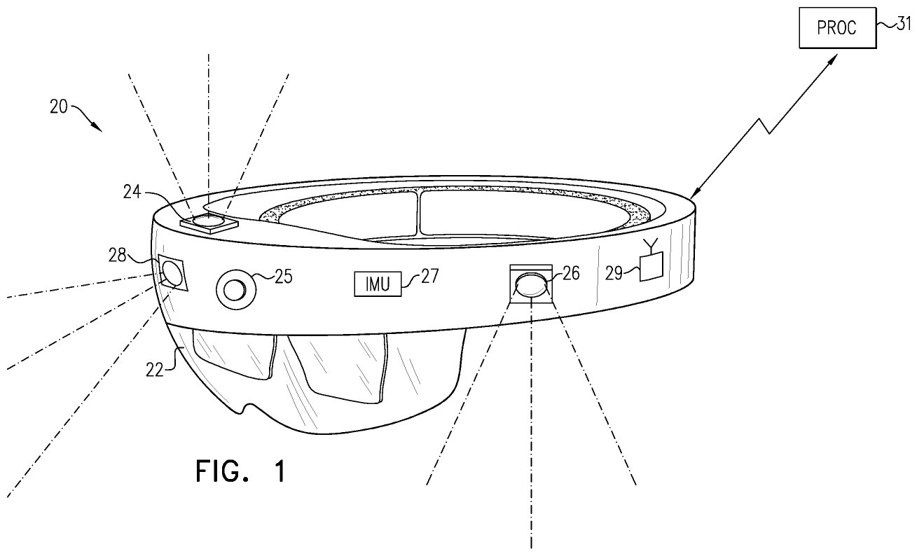

FIG. 1 is a schematic pictorial view of an AR headset 20 with 6-DOF localization, in accordance with an embodiment of the invention. Headset 20 projects images onto a visor 22, in registration with the external environment that the user views through the visor. A processor 31 shifts the projected images rapidly to compensate for motion of the user's head, so that the projected images maintain registration with the environment with little or no perceptible lag.

To sense movements of the user's head, headset 20 comprises one or more coherent sensing devices 24, 26, 28, which measure both radial and transverse distances and velocities of headset 20 relative to surfaces in the environment. (Alternatively, as noted above, the coherent sensing devices may be used to measure only radial distance and velocity, while transverse motion is measured by other criteria.) In the pictured example, device 24 is aimed upward and thus will sense distance and velocity with respect to the ceiling and possibly the walls (assuming the field of view is wide enough, and the user's head is appropriately oriented) of an indoor environment. Device 26 is oriented sideways and downward and thus will sense distance and velocity with respect to the floor or the ground, and possibly vertical surface, such as walls, as well.

In the pictured embodiment, headset 20 also comprises other sensors, such as a camera 25 and an IMU 27. A wireless transceiver 29, such as a Bluetooth® or Wi-Fi® transceiver, transmits signals from sensing devices 24, 26, 28 and from camera 25 and IMU 27 to processor 31 and receives instructions from the processor for driving the display on visor 22. Alternatively. processor 31 may be integrated into headset 20. Processor 31 receives and processes the signals that are output by sensing devices 24, 26, 28 and possibly from camera 25 and/or IMU 27 in order to extract displacement parameters of the sensing device relative to the surfaces in the environment and to compute coordinates of headset 20 based on the displacement parameters. Additionally or alternatively, processor 31 may use the displacement parameters in mapping the environment of headset 20.

Typically, processor 31 comprises a programmable microprocessor and/or digital signal processor, which is driven by software or firmware to carry out the functions that are described herein. Additionally or alternatively, the processor may comprise digital logic circuits, which may be hard-wired or programmable. The processor measures the frequencies of the beat signals that are output by sensing devices 24, 26, 28, extracts displacement parameters from these signals, and then combines the displacement parameters to compute the coordinates of headset 20 based on the known geometrical relation between the sensing devices.

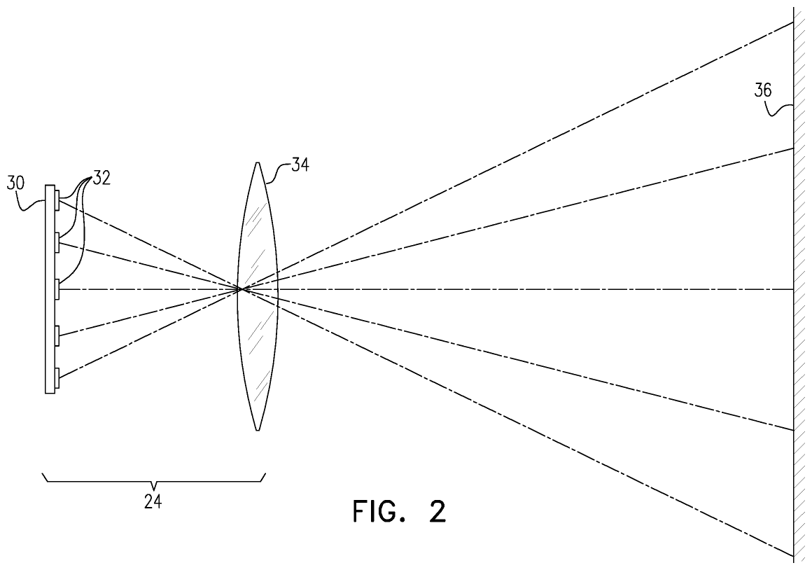

FIG. 2 is a schematic side view of sensing device 24, in accordance with an embodiment of the invention. Sensing devices 26 and 28 may be of similar design. Sensing device 24 comprises an array of sensing elements 32 on a substrate 30.

Each sensing element 32 comprises a coherent transceiver cell, which emits a modulated beam of coherent radiation, for example a beam that is modulated with a frequency chirp (or other modulation, such as random phase encoding). Imaging optics 34, such as a simple or compound lens, direct the beams from all of sensing elements 32 at different, respective angles into the environment of device 24. Alternatively, individual sensing elements 32 or groups of sensing elements may each have their own, separate imaging optics.

In the pictured example, these beams are incident at respective points on a surface 36. Optics 34 image these points back onto the receivers in the corresponding sensing elements. The received optical signals are mixed with a part of the transmitted beams using FMCW sensing techniques to generate beat signals, which are processed to find the distance and radial velocity of sensing device 24 relative to surface 36. Alternatively, sensing device 24 can alternate between sensing an unmodulated waveform for Doppler motion identification and a modulated waveform for range measurement. Such a scheme can improve range detection performance by mitigating the effect of the Doppler shift on the ranging signal.

In some embodiments, substrate 30 comprises a semiconductor substrate, such as a silicon-on-insulator (SOI) substrate, and sensing elements 32 are fabricated on the substrate using photonic integrated circuit (PIC) technology. PIC-based arrays of transceiver cells that may be used in sensing devices 24, 26 and 28 are described, for example in PCT International Publications WO 2023/023106, WO 2023/023105, WO 2023/034465, and WO 2023/076132, whose disclosures are incorporated herein by reference.

Although only a single column of sensing elements 32 is shown in the side view of FIG. 2. the sensing elements are typically arranged in a two-dimensional matrix. A sparse point cloud in the area of surface 36 is generally sufficient for the purposes of sensing device 24. Optical and/or electrical switching can be used to multiplex among the sensing elements, as described in the above-referenced PCT publications, for example. Alternatively or additionally, sensing device 24 may comprise a scanner (not shown in the figures), such as a rotating mirror, which scans the field of view of sensing elements 32; a movable mount, which shifts the position and/or orientation of substrate 30 or optics 34; or solid-state beam steering devices, such as a transmissive or reflective liquid-crystal-on-silicon spatial light modulator positioned before or after the optical lens. Such a scanner can be used to increase the density and/or transverse range of sensing of surface 36 by device 24, as described in the above-referenced PCT publications, for example.

### Measurement of Transverse Displacement

In addition to the beat signals provided by FMCW coherent sensing, the optical receivers in sensing elements 32 also capture an intensity image of the speckle patterns created by scattering of the beams of coherent radiation from surface 36. As long as sensing device 24 is stationary relative to surface 36, the image of the speckle pattern will be unchanged over the duration of the measurement. When sensing device 24 moves transversely or turns about an axis relative to surface 36, the speckle pattern that is imaged by optics 34 onto the sensing device will shift by a direction and amount that are related to the transverse motion or rotation and to the focal properties of optics 34. Processor 31 (FIG. 1) measures the optical flow of the speckle pattern across sensing elements 32 over time and thus calculates the transverse velocity of sensing device 24.

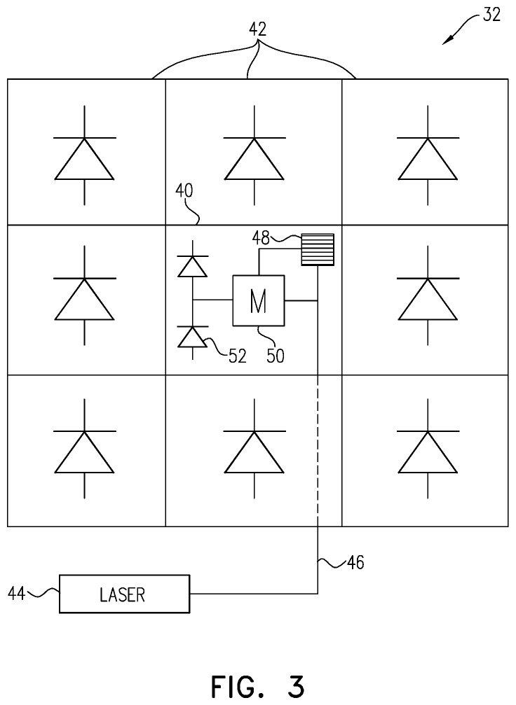

In order to capture a locally dense image of the speckle pattern using an otherwise sparse coherent pixel array, the fields of view of sensing elements 32 may be shifted over small angles so that each pixel maps its vicinity, as though it were a macro-pixel composed of multiple adjacent pixels, densely packed. Such a shift can be achieved, for example, by time-multiplexing of a single sensing “channel” to multiple spatial locations by slightly shifting optics 34 or substrate 30, or by introduction of a beam-displacer device close to the focal plane in order to shift the apparent location of the channel relative to the lens axis. (In other embodiments, these sorts of shifting techniques may be used in estimating the local geometry of a target by finding local normals to the surface of the target.) Alternatively or additionally, each sensing element 32 may comprise a physically dense pixel cluster. This sort of physically dense clustering can be achieved by dense packing of vertically coupled photodetectors, for example as shown in FIG. 3, or by a dense arrangement of edge-coupled photodetectors with suitable turning mirrors, such as the arrangement shown in FIGS. 20A-C of the above-mentioned PCT publication WO 2023/023106.

Optical flow of the speckles in the image captured by sensing elements 32 can be measured only over small ranges of motion, since the speckle pattern changes as the transmitted beams shift across surface 36. The range of speckle correlation can be increased by defocusing optics 34, i.e., positioning optics 34 relative to substrate 30 such that optics 34 image surface 36 onto a plane that is in front of or behind the actual array of sensing elements 32. (The resulting degradation of the transverse resolution of FMCW sensing due to defocusing of sensing device 24 should not substantially impair the ability of the sensing device to measure radial distance and velocity relative to surface 36, and sensing device 24 can be designed to achieve the optimal tradeoff between radial and transverse sensing resolution.) Sensing elements 32 can be sampled at high speed, for example in excess of 100 frames/sec, to ensure that the speckles in the image are correlated from frame to frame notwithstanding motion of sensing device 24.

FIG. 3 is a schematic frontal view of one of sensing elements 32 in device 24 or 26, in accordance with an embodiment of the invention. Sensing elements 32 of this sort may be arranged in a sparse two-dimensional array across substrate 30. Sensing element 32 in this embodiment comprises a coherent transceiver cell 40, surrounded by a local array of photodetectors 42. In the pictured example, sensing element 32 comprises a 3×3 matrix of photodetectors 42, but alternatively, a larger local array could be used to extend the area of speckle imaging.

A laser 44 injects a coherent beam, which may be frequency-modulated or phase-modulated, through a waveguide 46 on substrate 30 into transceiver cell 40 (and typically into the transceiver cells of the other sensing elements 32 on substrate 30, as well). A coupler 48, such as a surface grating, directs the transmitted beam perpendicularly outward, toward optics 34 (FIG. 2). Coupler 48 directs the optical radiation that is reflected from surface 36 via a waveguide into a suitable optical mixer 50, which mixes the received radiation with a “local oscillator” component split off from the transmitted beam. The resulting mixed optical signal is output to a photodetector 52, such as a balanced pair of photodiodes. The electrical signals output by photodetector 52 are processed to extract the beat signal generated due to the frequency shift of the reflected radiation, and this beat signal is analyzed to give the range (radial distance) and radial velocity between device 24 and surface 36. Additionally or alternatively, the optical receiver, following mixer 50, can implement phase-diversity (IQ-detection) and polarization-diversity configurations.

Photodetectors 42 output respective signals whose amplitudes are proportional to the local intensity of the speckle image formed by optics 34 on sensing element 32. Processor 31 (FIG. 1) correlates the signal amplitudes in successive frames to measure the direction and magnitude of translation and rotation of the speckles across sensing element 32. The processor uses the range derived from the FMCW measurement made by transceiver cell 40 as a scaling factor in translating the measured speckle motion into the actual incremental transverse motion of sensing device 34 relative to the external environment from frame to frame. This incremental motion is integrated over time to track the translational and rotational position of the platform, such as headset 20, on which sensing device 24 is mounted.

In an alternative embodiment (not shown in the figures), transverse motion is detected by sensing changes in the transverse modes of the reflections from surface 36 that are received by a group of edge-coupled waveguides, each terminating in a respective port of the edge coupler. Specifically, a multi-mode edge coupler may be used to create a “super-mode” structure, in which a “fundamental” LP01 (Gaussian-like) mode forms a reference channel, while higher-order modes are sensitive to X (LP11a) or Y (LP11b) displacements. Each port of the edge coupler is connected by a respective waveguide to a receiver channel, which measures the amplitude and phase of the incoming optical signal. One of the ports (for example the reference channel) is connected to a coherent optical transceiver for purposes of radial range and velocity measurements.

The time-varying differences between the signals received via the ports in the group are indicative of transverse motion. In particular, the complex field profiles associated with the X and Y modes defined above possess horizontal (X) and vertical (Y) asymmetries, due to the phase profile. Under transverse translation, the spatially correlated nature of the speckle field (when observed over short timescales) is converted into a temporal correlation between the spatial mode receivers. Specifically, analysis of the temporal correlation for the detected complex field (amplitude and phase) signals measured by the fundamental, X and Y receivers provides a measure of the transverse velocity.

### Example Use Cases

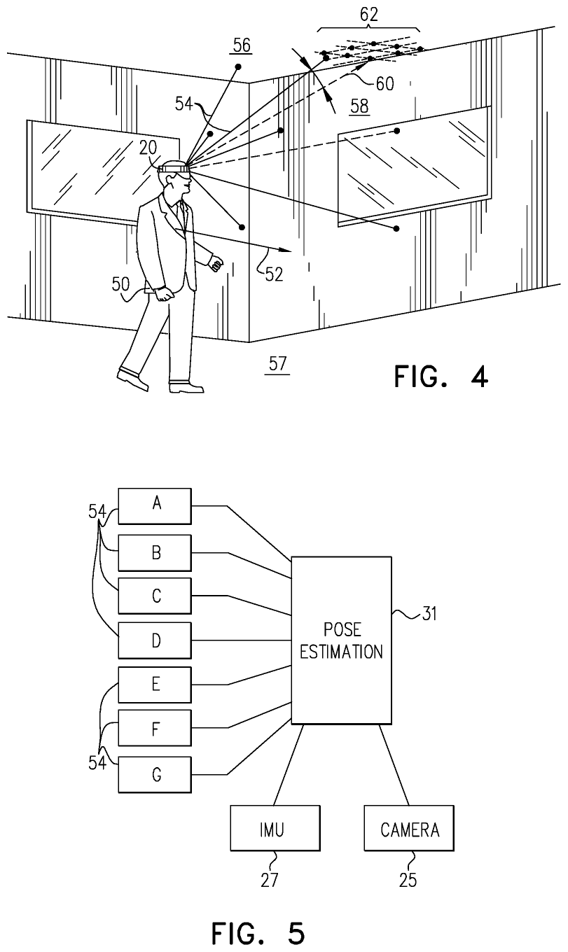

Reference is now made to FIGS. 4 and 5, which schematically illustrate the use of AR headset 20 in localizing a subject 50 in an indoor environment, in accordance with an embodiment of the invention. FIG. 4 is a schematic pictorial illustration, while FIG. 5 is a block diagram showing functional elements used in the localization operation performed in FIG. 4.

In the scenario shown in FIG. 4, headset 20 is worn by subject 50, who is moving along a vector 52. Sensing devices 24, 26, 28 (FIG. 1) on headset 20 are used by processor 31 in performing pose estimation and localization by projecting an array of laser beams 54 onto the scene and receiving return signals from the scene. The laser beams may be modulated, either externally or directly, with modulation comprising a frequency chirp or random frequency modulation. The reflected optical radiation is coherently mixed with local oscillator beams derived from laser beams 54 to yield the scene distance and radial velocity per beam.

Processor 31 infers the motion of subject 50 directly from the array of distances and velocities provided by beams 54, which are labeled A through G in FIG. 5. Loss or obscuration of any one of the beams is mitigated by having multiple beams and scene angles. The configuration of the sensing devices, including field of view and beam coverage, can be adjusted and optimized to meet application requirements. The outputs of the sensing devices can optionally be fused with the signals provided by IMU 27 and/or camera 25, which captures images of the same scene.

The environment shown in FIG. 4 includes several planar surfaces (including walls 58, floor 57, and ceiling 56) that are perpendicular or otherwise angled relative to one another. For purposes of accurate SLAM and velocity measurement, it can be useful to know the precise orientations of these surfaces, i.e., the angular orientation of the local normal to each surface. Assuming beams 54 to be sufficiently close to one another in angle so that several beams strike the same surface, the respective radial distance measurements can be combined to compute the local normal of the surface. Multiple local normals of this sort can be used to model the environment. This sort of modeling can be used, inter alia, in correcting for measurement drift.

In some embodiments, as explained above, sensing devices on headset 20 can also be used in measuring transverse displacement of the beams on a surface in the scene, for example of a beam 60 that impinges on ceiling 56. An array of photodetectors, as shown in FIG. 3 for example, measures the intensity of reflections received from a corresponding matrix 62 of points on ceiling 56. Processor 31 processes the changes in the signals received from the photodetectors to track speckle motion and thus measure the transverse velocity of beam 60 across ceiling 56. This measurement can use the speckle tracking sensors and algorithms that are described above. (Other sensors for this purpose are shown in the figures that follow.) The measurement of transverse displacement and velocity by speckle tracking can be performed in addition and in parallel to measurement of radial distance and velocity by coherent detection. These two types of measurements provide complementary information sources for pose estimation.

### Sensing Arrays

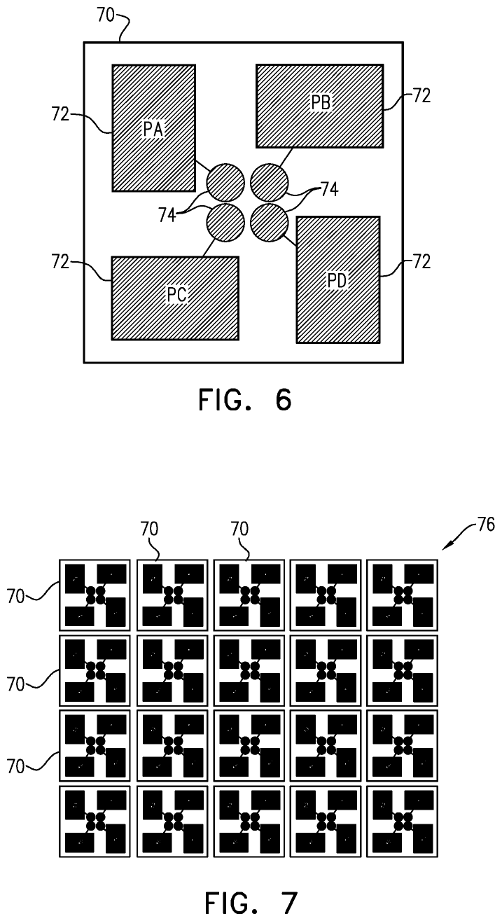

FIG. 6 is a schematic frontal view of a multi-pixel sensor 70 for use in a localization system, in accordance with an embodiment of the invention. Such a sensor may be used, for example, in place of sensors 24, 26, and 28 on headset 20 (FIG. 1). Sensor 70 has a locally dense pixel structure, with four separate, closely packed optical antennas 74 arranged in a 2×2 grid. Optical antennas 74 may comprise grating couplers or edge couplers, for example, each connected via waveguides to a separate (balanced) photodetector 72.

A subset of the optical antennas in each such multi-pixel sensor can measure scene distance and radial velocity, typically by coherent sensing as described above. In addition, each optical antenna samples the speckle intensity from a slightly different angle, such that under small device movement, the speckle field of the leading optical antenna is retraced by the trailing antennas. Since the object distance and angular separation between the antennas are known, sensing of the speckle field can be used to measure transverse movement of the platform to which the sensor is connected.

Alternatively, instead of or in addition to optical antennas, the sensing device may comprise direct light-sensing elements, for example vertical photodiodes, such as those shown in FIG. 3.

FIG. 7 is a schematic frontal view of a sensor array 76 for use in a localization system, in accordance with an embodiment of the invention. Array 76 comprises multiple sensors 70, which are packed side-by-side, for example on a PIC. The arrangement of array 76 enables measurement of distance and radial velocity, as well as speckle-based transverse movement, at multiple locations over the area of a scene.

FIG. 8 is a schematic pictorial view of a multi-pixel sensor 80 for use in a localization system, in accordance with another embodiment of the invention. In this case, an array of optical antennas 84 comprising grating couplers is arranged in a hexagonal pattern on a PIC 82. Optical antennas 84 are connected by respective waveguides to a sensing circuit 88, which performs both coherent measurements of radial distance and velocity and intensity-based measurements of transverse movement.

### Computation of Velocity With Six DoF

The sensing configuration shown in FIG. 1 may, alternatively or additionally, be used to compute the velocity of headset 20 with six DoF based only on the radial velocity measurements made by sensing devices 24, 26, 28, without reliance on measurements of location (by the sensing devices or other means) or on measurements of transverse movement. In the arrangement shown in FIG. 1, the beams of coherent radiation emitted by the sensing devices-and consequently the radial velocity measurements-span three dimensions. These radial velocity measurements will form a well-conditioned system as long as any direction of translational or rotational motion of headset 20 relative to its environment will give rise to a substantial change in at least one of the measurements. Six of the radial velocity measurements made by the sensing devices provide six independent velocity values. These values can be input to a system of six simultaneous linear equations to solve unambiguously for the three linear and three angular components of the absolute velocity of headset 20. Larger numbers of beams and measurements may be used to improve the accuracy of velocity computation and neutralize possible errors due to noise and moving objects in the measurement environment.

The absolute velocity components may be integrated over time to compute the position coordinates of headset 20. This integration may be based exclusively on the velocity measurements made by sensing devices 24, 26, 28, or it may be combined with measurements made by other sensors. For example, a gyroscope may be used to measure the orientation of headset 20, and this known orientation can then serve as the basis for transforming the velocity measurements to the static environment.

Additionally or alternatively, the same beams and sensors that are used for radial velocity measurements can also provide radial distance measurements for purposes of localization and/or SLAM, as described above. These distance measurements can be used, inter alia, in detecting and correcting for drift that may occur in integrating the velocity measurements.

Furthermore, when more than six beams are used, the additional beams may be used to sense motion of other objects in the vicinity of headset 20. For this purpose, processor 31 may compare and correlate the velocity values in order to infer which of the beams are reflected from moving objects and which are reflected from the static environment. Additionally or alternatively. the processor may convert the velocity (and location) measurements from the moving coordinate frame of headset 20 to the static coordinate frame of the environment. In this case, measurements of the velocities and locations of moving objects detected by sensing devices 24, 26, 28 can likewise be converted to the static coordinate frame.

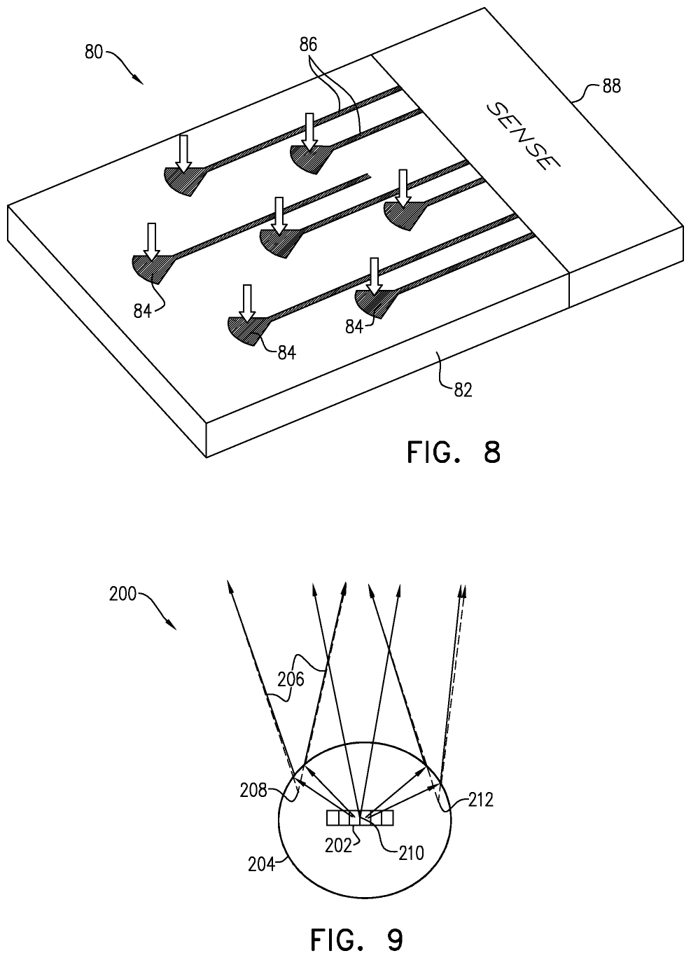

FIG. 9 is a schematic side view of a sensing device 200, which can be used for velocity sensing with 6 DoF in accordance with an embodiment of the invention. Device 200 includes an array 202 of optical transceivers and optics 204. Array 202 in this example comprises six transceivers, for example transceivers of the type illustrated by sensing element 32 in FIG. 3. Optics 204, such as a suitable lens or lens system, deflect beams 206 that are emitted by the transceivers such that when projected back to their virtual focal points, the beams originate from different points, for example from three different focal points 208, 210, and 212, as illustrated in FIG. 9. Beams 206 thus form three sets, with two beams in each set, such that the beam axes in each set do not intersect with the beam axes in any of the other sets. Alternatively, the separate virtual focal points may be created by other means, for example using reflective optics in addition to or instead of the refractive optics illustrated in FIG. 9.

Based on the reflections received from the environment of sensing device 200, each transceiver measures a respective value of radial velocity. Processor 31 combines the respective radial velocity values to compute the velocity of sensing device 200 with six DoF. The condition that beams 206 do not share a common point of origin, or even originate from only two common points, is a necessary but not sufficient condition for ensuring that the six radial velocity measurements are linearly independent of one another, so that the set of equations used to derive the linear and angular velocity components of device 200 is fully determined. On the other hand, when sensing is constrained to a plane, only three beams may be necessary.

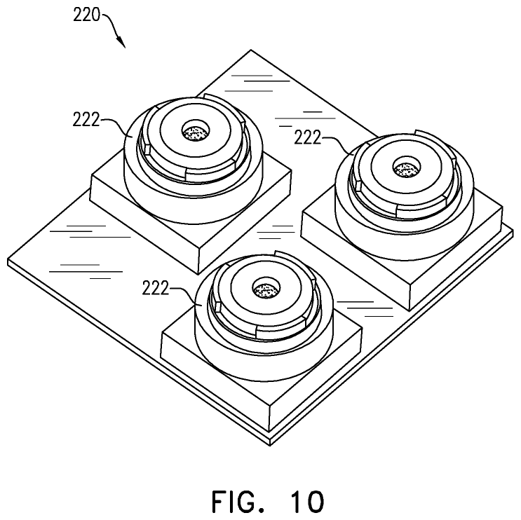

FIG. 10 is a schematic side view of a sensing array 220, comprising three coherent sensing devices 222, which measure radial distance and velocity, in accordance with another embodiment of the invention. Typically each sensing device 222 comprises an array of sensing elements, for example as shown above in FIG. 2. Sensing devices 222 in this embodiment are coplanar but not collinear, and thus enable sensing with six DoF as described above. It is advantageous that the sensing devices not be coplanar, however, for example as in the embodiment shown in FIG. 1.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for sensing, comprising:
transmitting multiple beams of coherent optical radiation at different, respective beam angles from an array of transceivers mounted on a platform;
receiving at two or more of the transceivers reflections of the beams from two or more different, respective surfaces at different, respective orientations relative to the platform;
processing the received reflections at the transceivers coherently with the transmitted beams to extract displacement parameters of the transceivers relative to the respective surfaces; and
computing coordinates of the platform based on the displacement parameters.

2. The method according to claim 1, wherein at least two of the surfaces from which the reflections are received are oriented relative to the platform at respective orientation angles that differ by more than 10°.

3. The method according to claim 2, wherein the respective orientation angles differ by 90°.

4. The method according to claim 1, wherein the array of transceivers is disposed on a photonic integrated circuit (PIC).

5. The method according to claim 1, wherein the transceivers in the array have respective fields of view, which are not mutually overlapping.

6. The method according to claim 1, wherein the displacement parameters are selected from a set of parameters consisting of radial distances and radial velocities relative to the surfaces.

7. The method according to claim 6, wherein processing the received reflections further comprises extracting a transverse velocity of at least one of the transceivers by detecting movement of a laser speckle pattern cast by at least one of the beams on at least one of the surfaces.

8. The method according to claim 7, wherein detecting the movement comprises sensing changes in an intensity of the reflections using a matrix of photodetectors adjacent to the at least one of the transceivers.

9. The method according to claim 7, wherein detecting the movement comprises sensing changes in a transverse mode of the reflections received by a group of edge-coupled waveguides.

10. The method according to claim 1, wherein computing the coordinates comprises computing location coordinates of the platform.

11. The method according to claim 1, wherein computing the coordinates comprises computing velocity coordinates of the platform.

12. The method according to claim 11, wherein computing the velocity coordinates comprises computing three linear components and three angular components of a velocity of the platform.

13. The method according to claim 11, wherein computing the coordinates comprises integrating the velocity coordinates over time to find location coordinates of the platform.

14. The method according to claim 1, wherein transmitting the multiple beams comprises transmitting three or more of the beams of coherent optical radiation along three or more different, non-intersecting axes.

15-17. (canceled)

18. A method for sensing, comprising:
transmitting three or more beams of coherent optical radiation along three or more different, non-intersecting axes from an array of transceivers mounted on a platform;
receiving at the transceivers reflections of the beams from one or more surfaces along the different, non-intersecting axes;
processing the received reflections at the transceivers coherently with the transmitted beams to extract displacement parameters of the transceivers relative to the one or more surfaces; and
computing coordinates of the platform based on the displacement parameters.

19. The method according to claim 18, wherein transmitting the three or more beams comprises transmitting at least six beams of the coherent optical radiation along different, respective axes, forming at least three sets of the axes such that the axes in each set do not intersect with the axes in any of the other sets.

20. The method according to claim 19, wherein the extracted displacement parameters comprise respective radial velocities along the respective axes relative to the one or more surfaces.

21. The method according to claim 20, wherein computing the coordinates comprises computing three linear components and three angular components of a velocity of the platform.

22. The method according to claim 21, wherein computing the coordinates comprises integrating the linear and angular components of the velocity over time to find location coordinates of the platform.

23. The method according to claim 18, wherein the array of transceivers is disposed on a photonic integrated circuit (PIC).

24. The method according to claim 18, wherein the transceivers in the array have respective fields of view, which are not mutually overlapping.

25. The method according to any of claims 18-24, wherein the displacement parameters are selected from a set of parameters consisting of radial distances and radial velocities relative to a surface.

26. The method according to claim 25, wherein processing the received reflections further comprises extracting a transverse velocity of at least one of the transceivers by detecting movement of a laser speckle pattern cast by at least one of the beams on at least one of the surfaces.

27. The method according to claim 25, wherein computing the coordinates comprises computing a linear combination of the displacement parameters.

28-31. (canceled)

32. The method according to claim 18, wherein the one or more surfaces comprise multiple different surfaces, including first and second surface on which at least first and second ones of the beams of coherent optical radiation are incident, and wherein the method comprises computing a velocity of the second surface relative to the first surface based on the displacement parameters.

33. (canceled)

34. Sensing apparatus, comprising:
an array of transceivers, which are configured for mounting on a platform and are configured to transmit multiple beams of coherent optical radiation at different, respective beam angles, to receive at two or more of the transceivers reflections of the beams from two or more different, respective surfaces at different, respective orientations relative to the platform, to mix the received reflections coherently with the transmitted beams, and to output signals responsively to the mixed reflections; and
a processor configured to process the signals to extract displacement parameters of the transceivers relative to the one or more surfaces and to compute coordinates of the platform based on the displacement parameters.

35. The apparatus according to claim 34, wherein at least two of the surfaces from which the reflections are received are oriented relative to the platform at respective orientation angles that differ by more than 10°.

36. The apparatus according to claim 35, wherein the respective orientation angles differ by 90°.

37. The apparatus according to claim 34, wherein the array of transceivers is disposed on a photonic integrated circuit (PIC).

38. The apparatus according to claim 34, wherein the transceivers in the array have respective fields of view, which are not mutually overlapping.

39. The apparatus according to claim 34, wherein the displacement parameters are selected from a set of parameters consisting of radial distances and radial velocities relative to the surfaces.

40. The apparatus according to claim 39, wherein the processor is configured to extract a transverse velocity of at least one of the transceivers by detecting movement of a laser speckle pattern cast by at least one of the beams on at least one of the surfaces.

41. The apparatus according to claim 40, and comprising a matrix of photodetectors adjacent to the at least one of the transceivers, wherein the processor is configured to detect the movement of the laser speckle pattern by sensing changes in an intensity of the reflections using the matrix of photodetectors.

42. The apparatus according to claim 40, wherein the processor is configured to detect the movement of the laser speckle pattern by sensing changes in a transverse mode of the reflections received by a group of edge-coupled waveguides.

43. The apparatus according to claim 34, wherein the processor is configured to compute location coordinates of the platform based on the displacement parameters.

44. The apparatus according to claim 34, wherein the processor is configured to compute velocity coordinates of the platform based on the displacement parameters.

45. The apparatus according to claim 44, wherein the velocity coordinates comprise three linear components and three angular components of a velocity of the platform.

46. The apparatus according to claim 44, wherein the processor is configured to integrate the velocity coordinates over time to find location coordinates of the platform.

47. The apparatus according to claim 34, wherein the array of transceivers is configured to transmit three or more of the beams of coherent optical radiation along three or more different, non-intersecting axes.

48-50. (canceled)

51. Apparatus for sensing, comprising:
an array of transceivers, which are configured for mounting on a platform and are configured to transmit three or more beams of coherent optical radiation along three or more different, non-intersecting axes, to receive reflections of the beams from one or more surfaces along the different, non-intersecting axes, to mix the received reflections coherently with the transmitted beams, and to output signals responsively to the mixed reflections; and
a processor configured to process the signals to extract displacement parameters of the transceivers relative to the one or more surfaces and to compute coordinates of the platform based on the displacement parameters.

52. The apparatus according to claim 51, wherein the transceivers are configured to transmit at least six beams of the coherent optical radiation along different, respective axes, forming at least three sets of the axes such that the axes in each set do not intersect with the axes in any of the other sets.

53. The apparatus according to claim 52, wherein the extracted displacement parameters comprise respective radial velocities along the respective axes relative to the one or more surfaces.

54. The apparatus according to claim 53, wherein the processor is configured to compute, based on the extracted displacement parameters, three linear components and three angular components of a velocity of the platform.

55. The apparatus according to claim 54, wherein the processor is configured to integrate the linear and angular components of the velocity over time to find location coordinates of the platform.

56. The apparatus according to claim 51, wherein the array of transceivers is disposed on a photonic integrated circuit (PIC).

57. The apparatus according to claim 51, wherein the transceivers in the array have respective fields of view, which are not mutually overlapping.

58. The apparatus according to claim 51, wherein the displacement parameters are selected from a set of parameters consisting of radial distances and radial velocities relative to a surface.

59. The apparatus according to claim 58, wherein the processor is configured to extract a transverse velocity of at least one of the transceivers by detecting movement of a laser speckle pattern cast by at least one of the beams on at least one of the surfaces.

60. The apparatus according to claim 58, wherein the processor is configured to find the coordinates by computing a linear combination of the displacement parameters.

61-64. (canceled)

65. The apparatus according to claim 51, wherein the one or more surfaces comprise multiple different surfaces, including first and second surface on which at least first and second ones of the beams of coherent optical radiation are incident, and wherein the processor is configured to compute a velocity of the second surface relative to the first surface based on the displacement parameters.

66. The apparatus according to claim 51, wherein the processor is configured to map an environment of the platform using the extracted displacement parameters.
